(19) United States
(12) Patent Application Publication
(10) Pub. No.: US 2008/0075318 A1
(43) Pub. Date: Mar. 27, 2008

(54) SPIDER WITH SPIRAL TINSEL LEAD AND TRANSDUCER AND LOUDSPEAKER COMPRISING SAME

(76) Inventor: Zhijun (Bob) Zhao, Stillwater, OK (US)

Correspondence Address: MARY M LEE, P.C., 1300 E. NINTH STREET, SUITE 4, EDMOND, OK, 73034-5760, US

(21) Appl. No.: 11/845,857

(22) Filed: Aug. 28, 2007

Related U.S. Application Data
(60) Provisional application No. 60/823,801, filed on Aug. 29, 2006.

(51) Int. Cl. H04R 9/06; H04R 1/00; H04R 11/02

(52) U.S. Cl. 381/404

(57) ABSTRACT

A spider for a loudspeaker. The spider comprises a spider plate with integrated leads. The spider plate is an annular plate that forms a wave shape in the radial section. Each lead, when installed, assumes a generally spiral shape passing up and down through the spider plate along its length so the spiral formed by the installed lead extends radially from the inner opening of the spider plate. The internal abrasion of the leads is very small; the reliability and lifespan of the leads are increased, and loudspeaker power is enhanced, and loudspeaker operating time is extended.

### CROSS-REFERENCE TO RELATED APPLICATION(S)

This application claims the benefit of the filing date of provisional application No. 60/823,801, entitled “Spider with Spiral Tinsel Lead and Loudspeaker Comprising Same,” filed Aug. 29, 2006, and the contents of this prior application are incorporated herein by nature.

### FIELD OF THE INVENTION

This present invention relates generally to spiders with integrated lead wires for use in loudspeakers and to transducers and loudspeakers comprising such spiders.

### BACKGROUND OF THE INVENTION

Conventional moving coil loudspeakers include a frame, a power system, a cone, and a suspension system. The power system, cone and suspension system are all arranged inside the frame. The power system includes a magnet, a pole piece, a coil gap, and a voice coil. The cone is the diaphragm that vibrates the air, and it is usually forms a cone-shaped or hemispheric sound basin. The suspension system is composed of a spider and suspended edge structure or surround installed between the frame and sound basin. The suspension system guides the directional vibrations of the diaphragm.

A signal terminal installed on the frame is connectable to a signal source, and a lead wire connects the signal terminal to the voice coil. When an external signal passes through the signal terminal and travels into the voice coil, it produces an electromagnetic field. The magnetic effects of this electromagnetic field and the permanent magnet cause the voice coil to reciprocate in the gap, which in turn causes the diaphragm to move, thus causing the air to vibrate and transmit emitted audio frequency. In this way, the electrical energy is converted into acoustic energy; in other words, the electric signal is converted to sound.

FIG. 1 shows a conventional transducer for a loudspeaker, the transducer designated generally at 10. The outer edge of the diaphragm 12 is supported in the front of the frame 14 by the surround 16. The spider 20 supports the voice coil. The tinsel lead 22 stretches across and is suspended over the spider 20, one end connected to the signal terminal and the other end connected on the voice coil. This traditional type of wire connection method has major limitations. For example, the lead 22 experiences a so-called “rope skipping” phenomenon, and over a period of time the rope skipping may cause the lead to break, especially near the areas of the signal terminal and the voice coil. If the tinsel lead is longer, it tends to lash about on the voice coil or spider, which can seriously affect the sound quality.

In light of the above-mentioned drawbacks of the traditional loudspeaker structure, there have been improvements in which tinsel leads are combined with the spider. Although these wire connection methods are somewhat improved beyond the traditional method, there remains a need for a spider and tinsel lead combination with improved performance. Because the tinsel leads pass along the radial direction of the spider, there is significant relative movement between the tinsel leads and spider when the spider is operating. This often causes the tinsel leads to be damaged or loosened as a result of the friction caused by the movement. Because the tinsel leads that passes along the radial direction of the spider on the spider, the range of vertical movement is quite large, and this results in large stress and drag on the lead, again leading to damage and even breaking as a result of the fatigue.

### BRIEF DESCRIPTION OF THE DRAWINGS

FIG. 1 shows a prior art speaker with a conventional transducer with a “loose” tinsel lead connected only at the signal terminals and the voice coil.

FIG. 2 is a vertical sectional view of a transducer comprising a spider made in accordance with the present invention.

FIG. 3 is a schematic illustration of how the leads are attached to spider in accordance with the present invention.

FIG. 4 is a perspective view of a spider made in accordance with the present invention in which the leads are threaded through the spider plate in a spiral pattern.

FIG. 5 is a plan view of the spider shown in FIG. 5.

FIG. 6 is a cross-sectional view of the spider shown in FIG. 4 taken along the line 6-6.

FIG. 7 is a plan view of the spider plate of the spider shown in FIG. 4 with the leads removed to show the pattern of holes formed in the spider plate.

### DETAIL DESCRIPTION OF THE PREFERRED EMBODIMENT(S)

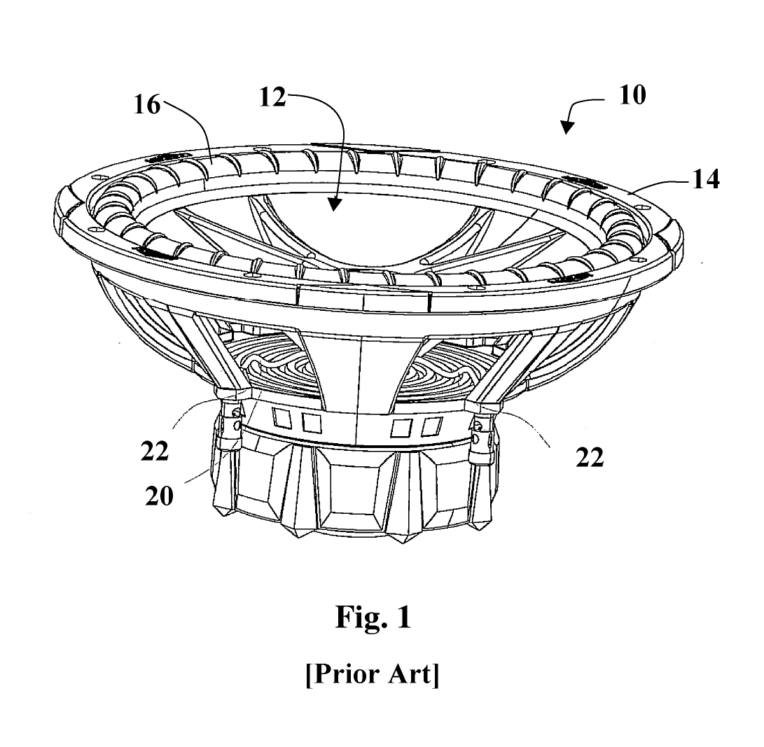

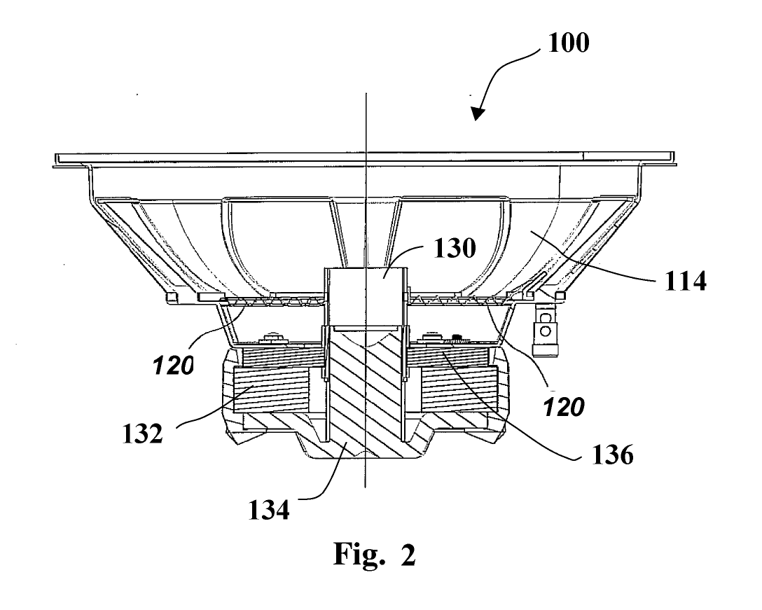

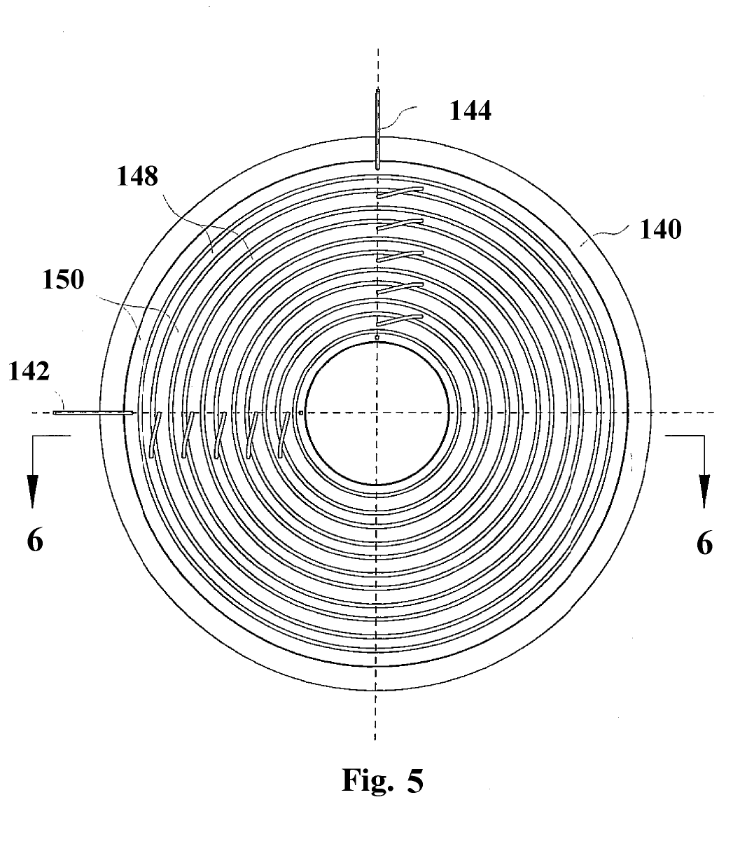

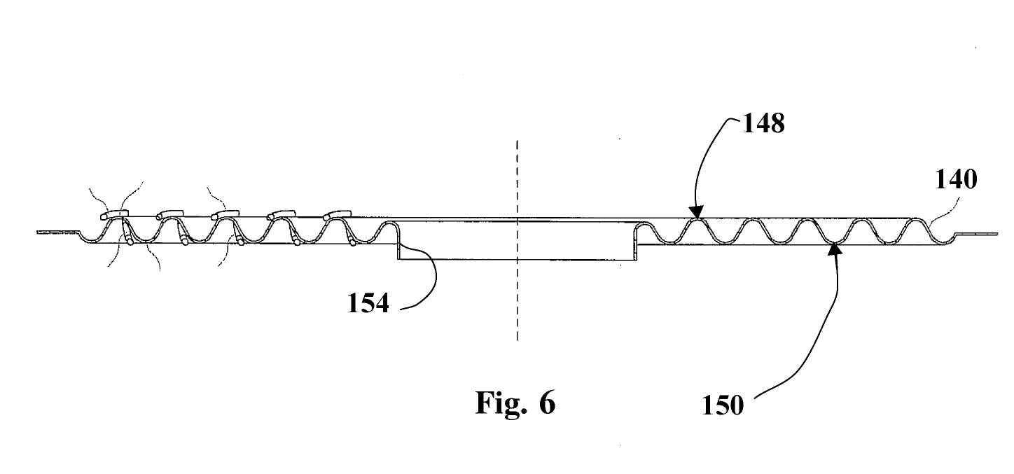

Turning now to FIGS. 2-7, there is shown therein a loudspeaker in accordance with the present invention. In the preferred embodiment shown, the loudspeaker comprises an enclosure (not shown) and a transducer designated in FIG. 2 generally as 100. The structure and operation of the transducer 100 is generally the same as in the prior art transducer 10 of FIG. 1. The diaphragm (not shown) is supported inside the front of the frame 114 by a flexible surround (not shown). The inner edge of the diaphragm is attached to the coil former 130 in a known manner.

The spider 120 comprises an annular body with a central opening that is attached to the coil former 130. The outer edge of the spider 120 is attached to the frame 116. A permanent magnet 132 is positioned between the rear of the pole piece 134 and the front plate 136.

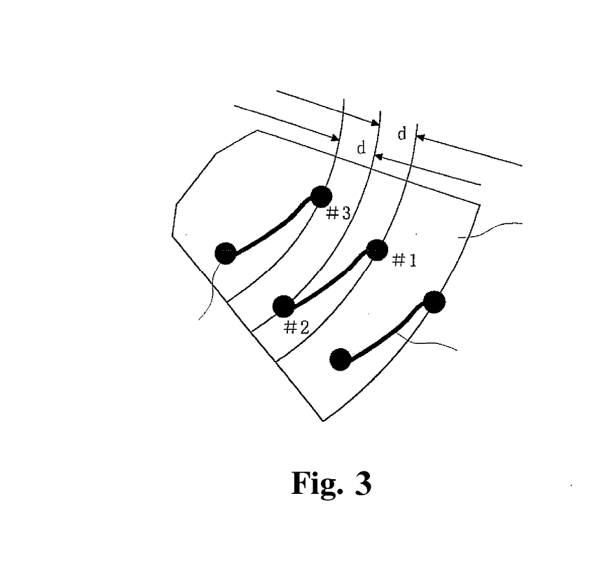

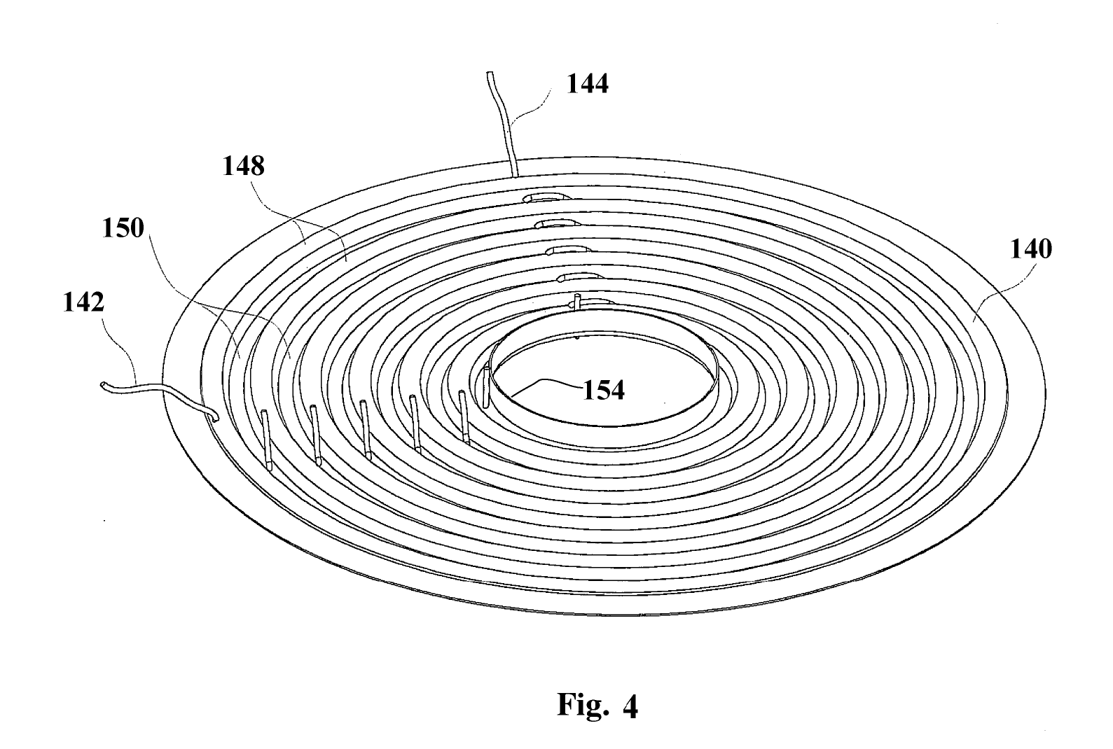

The structure of the spider 120 is shown in more detail in FIGS. 3-7, to which attention now is directed. As seen in FIGS. 4-7, the spider comprises an annular plate 140 and a pair of tinsel leads 142 and 144. The plate 140 is corrugated, that is, the plate has a wave shape in the radial section, forming repeating wave peaks 148 and wave troughs 150. The center of the plate 140 defines a central opening 154 which receives the coil former 130 (FIG. 2).

The leads 142 and 144 are threaded through the plate 140 in a spiral or helical pattern. The leads 142 and 144 can be fixed on the spider plate 140 by means of the pass-through installation method as well as the sewing method, and yet the pass-through installation method is preferred.

The sewing method refers to using binding wire to sew the leads on the spider plate. The pass-through installation method refers to having two series of fixed holes, where the leads are passed back and forth and are then installed between the two series of fixed holes, forming the spiral pattern on the spider plate. The set location of the fixed holes can be in the wave peak area as well as the wave trough area, and it can also be between the wave peak and wave trough.

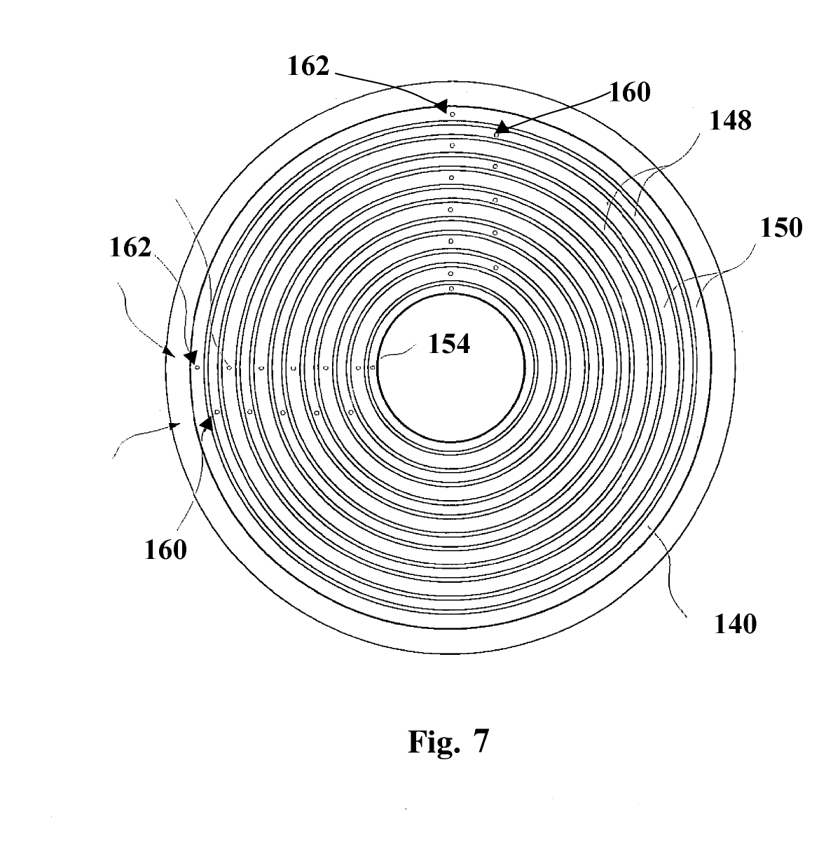

However, the preferred fixed holes installation method is to weave the leads through alternating wave peaks and troughs. In this embodiment, as seen in FIG. 7, one of the two series of fixed holes includes fixed holes 160 that are arranged in the wave peak areas 148 of the said spider, and the other series of fixed holes includes fixed holes 162 arranged in the wave trough areas 150 of the spider plate 140.

Each series of fixed holes can be installed in the space relative to the wave peak or wave trough, and they can also be installed in sequence. However, the latter is preferred, that is, each wave peak area 148 of the spider plate 140 has one fixed hole 160, and correspondingly, each wave trough 150 also has one fixed hole 162.

The two series of fixed holes 160 and 162 are separately arranged in two straight lines. The trend of at least one of the two straight lines runs along the radial direction of the said spider, and moreover, the edit point in and the edit point out of the tinsel lead on the spider plate 140 are located on this radial straight line. The two straight lines are parallel to each other. The tinsel leads preferably are covered with a layer of pigtail wire. As shown in the preferred embodiment, two leads 142 and 144 are about perpendicular to each other, that is, forming an angle of about 90 degrees. However, especially where the speaker has a single voice coil, the angle formed the leads may be greater than or less than 90 degrees. If the loudspeaker has dual coils, the preferred angle between two adjacent tinsel leads is 90 degrees. The pass-through area of each of the tinsel leads 142 and 144 and spider plate 140 is coated with flexible fixing glue.

Using the example shown in FIG. 3, the length between the former two fixed points or vulnerable points was basically equivalent to the two adjoining wave peaks. The radial distance between the wave troughs was ‘d’, and the length between the two fixed points or vulnerable points was basically equivalent to the length between Point #1 and Point #2, or the length between Point #2 and Point #3. Therefore, given the same vibration range, when comparing the tinsel leads in the spider of this invention with the tinsel leads in conventional tinsel lead spiders, the vibration ranges and buckling degrees of the tinsel leads on the unit length are smaller, and the sustained internal stresses are reduced. As a result, the internal abrasion of the leads is smaller, and; the reliability and lifetime of the leads is increased. This results in a loudspeaker with increased power efficiency and a longer operating time.

What is claimed is:

1. A spider for use in the transducer of a loudspeaker, the spider comprising:
a spider plate with an central opening and an outer edge;
a pair of leads, each leads being integrated with the spider plate so that it assumes a generally spiral shape passing up and down through the spider plate along its length and so the spiral formed by the lead extends radially from the central opening of the spider plate to its outer edge.

2. A transducer for a loudspeaker, the transducer comprising:
a frame having a front opening and a body with a rear portion;
a surround having an inner edge and an outer edge, the outer edge supported in the front opening of the frame; and
a diaphragm having a center portion and an outer edge, the outer edge supported by the inner edge of the surround;
an annular permanent magnet supported in the rear portion of the frame, the magnet having a central opening;
a coil former having an upper end attached to the central portion of the diaphragm;
a voice coil wound on the former in a magnetic gap between the former and the central opening in the permanent magnet;
a signal terminal on the frame adapted for connection to a signal source;
a spider comprising:
a spider plate with a central opening and an outer edge, the outer edge supported on the body of the frame and the inner opening positioned around the upper end of the coil former;
a pair of leads connecting the signal terminal to the voice coil, each leads being integrated with the spider plate so that it assumes a generally spiral shape passing up and down through the spider plate along its length and so the spiral formed by the lead extends radially from the central opening of the spider plate to its outer edge.

3. A loudspeaker comprising:
an enclosure;
a transducer supported in the enclosure, the transducer comprising:
a frame receivable in the enclosure, the frame having a front opening and a body with a rear portion;
a surround having an inner edge and an outer edge, the outer edge supported in the front opening of the frame; and
a diaphragm having a center portion and an outer edge, the outer edge supported by the inner edge of the surround;
an annular permanent magnet supported in the rear portion of the frame, the magnet having a central opening;
a coil former having an upper end attached to the central portion of the diaphragm;
a voice coil wound on the former in a magnetic gap between the former and the central opening in the permanent magnet;
a signal terminal on the frame adapted for connection to a signal source;
a spider comprising:
a spider plate with a central opening and an outer edge, the outer edge supported on the body of the frame and the inner opening positioned around the upper end of the coil former;
a pair of leads connecting the signal terminal to the voice coil, each leads being integrated with the spider plate so that it assumes a generally spiral shape passing up and down through the spider plate along its length and so the spiral formed by the lead extends radially from the central opening of the spider plate to its outer edge.

4. A method for making a spider with integrated tinsel leads, the method comprising:
forming a spider plate with concentric corrugations between in inner opening and an outer edge;
installing first and second tinsel leads in the spider plate so that each lead, when installed, assumes a generally spiral shape passing up and down through the spider plate along its length so the spiral formed by the installed lead extends radially from the inner opening of the spider plate.
